(19) United States
(12) Patent Application Publication
(10) Pub. No.: US 2026/0230904 A1
(43) Pub. Date: Aug. 6, 2026

(54) DATA FLOW-AWARE ADMISSION CONTROL

(71) Applicant: InterDigital Patent Holdings, Inc., Wilmington, DE (US)

(72) Inventors: Magurawalage Chathura Madhusanka Sarathchandra, London (GB); Michael Starsinic, Newtown, PA (US); Samuli Turtinen, Ii (FI); Xavier De Foy, Kirkland (CA); Kevin Di Lallo, Laval (CA); Rocco Di Girolamo, Laval (CA)

(73) Assignee: InterDigital Patent Holdings, Inc., Wilmington, DE (US)

(21) Appl. No.: 19/047,304

(22) Filed: Feb. 6, 2025

(51) Int. Cl. H04W 28/02; H04W 72/1263; H04W 80/10

(52) U.S. Cl. CPC H04W 28/0268; H04W 72/1263; H04W 80/10

(57) ABSTRACT

Systems, methods, and instrumentalities are described herein related to data flow-aware admission control. In examples, a first network node may be configured to receive a first quality of service (QoS) profile that includes information associated with a plurality of service data flows (SDFs) multiplexed onto a first QoS flow associated with the first QoS profile. The first network node may indicate that the first QoS flow was denied admission and can be admitted if a first condition is satisfied. The first network node may receive a second QoS profile associated with a second QoS flow. The second QoS profile may satisfy a second condition associated with the first condition. The first network node may determine that the second QoS flow can be admitted based on the second QoS profile satisfying the second condition. The first network node may indicate that the second QoS flow can be admitted.

### BACKGROUND

Mobile communications using wireless communication continue to evolve. A sixth generation may be referred to as 6G. A fifth generation may be referred to as 5G. A previous (e.g., legacy) generation of mobile communication may be, for example, fourth generation (4G) long term evolution (LTE).

### SUMMARY

Systems, methods, and instrumentalities are described herein related to data flow-aware admission control.

In examples, a first network node may be configured to receive, from a second network node, a first message. The first network node may be a radio access network (RAN) and the second network node may be a session management function (SMF). The first network node may be a radio access network (RAN) and the second network node may be an access and mobility function (AMF). The first message may include a first quality of service (QoS) profile. The first QoS profile may include information associated with a plurality of service data flows (SDFs). The information associated with the plurality of SDFs may include at least one of: a requested 5GS delay, a requested priority, a requested guaranteed bitrate, a requested maximum bitrate, a maximum burst size, or a request packet error rate for an SDF of the plurality of SDFs. The plurality of SDFs may be multiplexed onto a first QoS flow associated with the first QoS profile. The first network node may determine that the first QoS flow was denied admission.

The first network node may determine that the first QoS flow can be admitted if a first condition is satisfied. The first condition may be satisfied if the first QoS flow has a subset of the plurality of SDFs multiplexed onto the first QoS flow. The first condition may be satisfied if radio access network (RAN) capabilities associated with the first QoS flow are met. The RAN capabilities associated with the first QoS flow may be met if the first QoS flow is below a QoS flow capacity. The first condition may be based on at least one of: the plurality of SDFs multiplexed onto the first QoS flow, information associated with the plurality of SDFs multiplexed onto the first QoS flow, or an indication that the first QoS flow has the plurality of SDFs multiplexed onto the first QoS flow.

The first network node may send, to the second network node, a first response. The first response may indicate the first QoS flow was denied admission and can be admitted if the first condition is satisfied. The first network node may receive, from the second network node, a second message. The second message may include a second QoS profile. The second QoS profile may be associated with a second QoS flow. The second QoS profile may satisfy a second condition associated with the first condition. The second condition may be satisfied if the second QoS flow has the subset of the plurality of SDFs multiplexed onto the second QoS flow. The second condition may be satisfied if RAN capabilities associated with the second QoS flow are met. The RAN capabilities associated with the second QoS flow may be met if the second QoS flow is below the QoS flow capacity.

The first network node may determine that the second QoS flow can be admitted based on the second QoS profile satisfying the second condition. The first network node may send, to the second network node, a second response. The second response may indicate that the second QoS flow can be admitted.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates example packet data unit (PDU) session resource setup procedures.

FIG. 3 illustrates example procedures used by the access and mobility management function (AMF) to initiate a handover by sending a handover request message to the target NG-RAN node.

FIG. 4 illustrates an example of multiplexing traffic from multiple service data flows (SDFs) onto a single quality of service (QoS) flow.

FIG. 5 illustrates an example procedure for how the RAN can make admission control decisions for a QoS flow based on the parameters or requirements of the SDFs that are multiplexed within the QoS flow.

FIG. 6 illustrates an example related to data flow-aware admission control.

### DETAILED DESCRIPTION

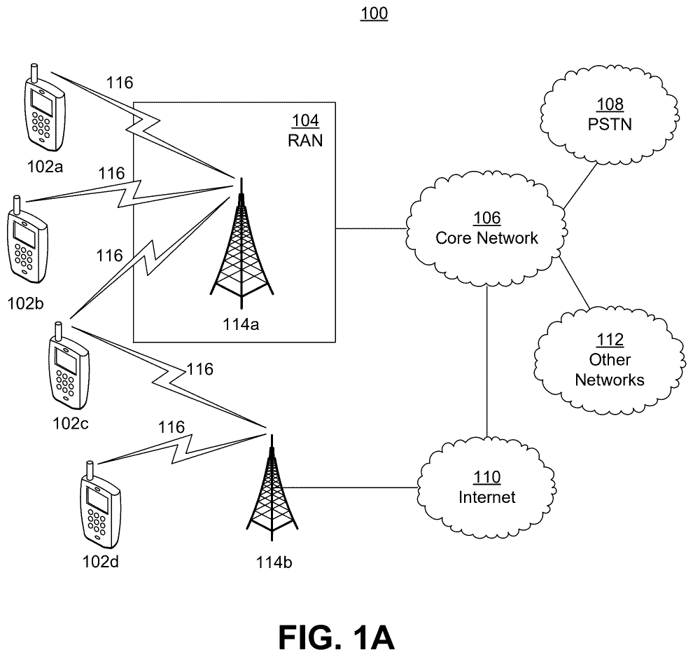

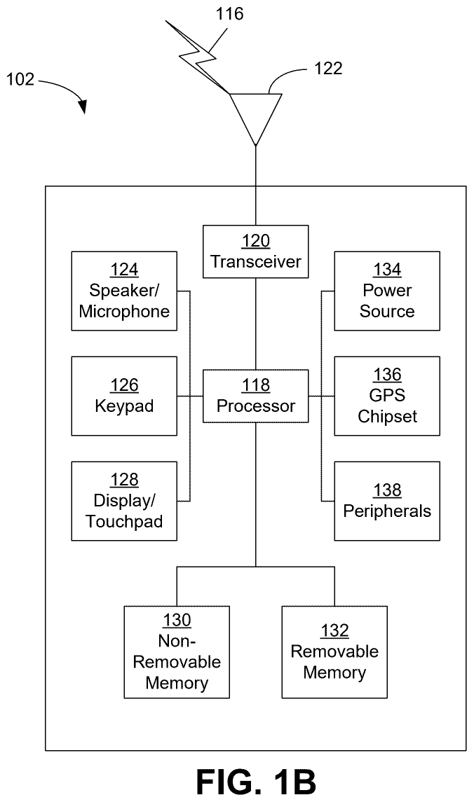

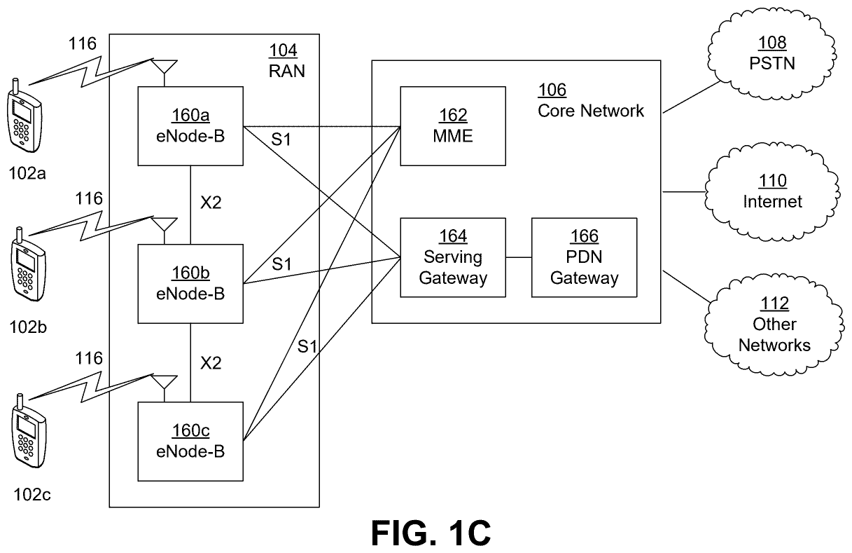

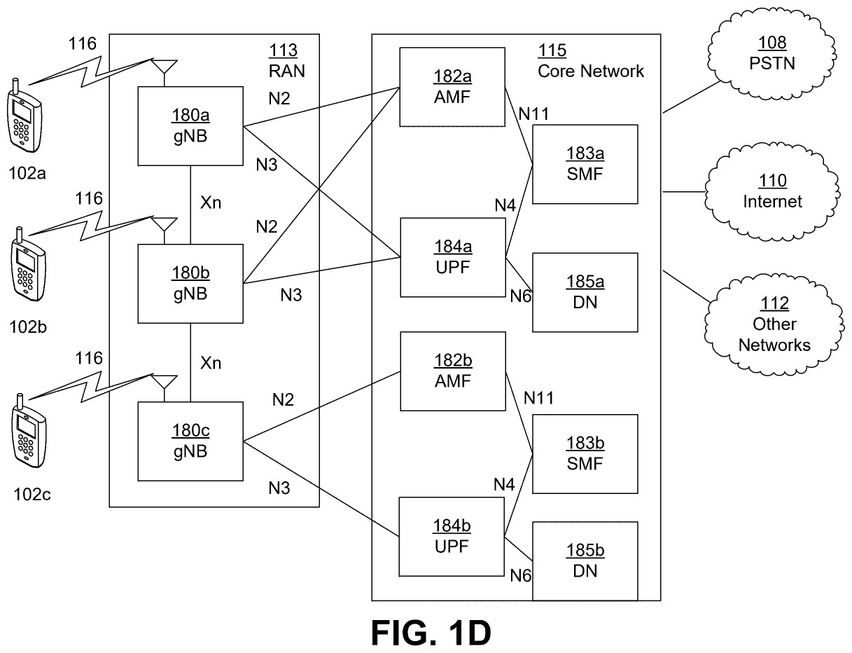

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a node-B, an eNode B, a Home node B, a Home eNode B, a gNB, a NR nodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183Ran a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Systems, methods, and instrumentalities are described herein related to data flow-aware admission control.

In examples, a first network node may be configured to receive, from a second network node, a first message. The first network node may be a radio access network (RAN) and the second network node may be a session management function (SMF). The first network node may be a radio access network (RAN) and the second network node may be an access and mobility function (AMF). The first message may include a first quality of service (QoS) profile. The first QoS profile may include information associated with a plurality of service data flows (SDFs). The information associated with the plurality of SDFs may include at least one of: a requested 5GS delay, a requested priority, a requested guaranteed bitrate, a requested maximum bitrate, a maximum burst size, or a request packet error rate for an SDF of the plurality of SDFs. The plurality of SDFs may be multiplexed onto a first QoS flow associated with the first QoS profile. The first network node may determine that the first QoS flow was denied admission.

The first network node may determine that the first QoS flow can be admitted if a first condition is satisfied. The first condition may be satisfied if the first QoS flow has a subset of the plurality of SDFs multiplexed onto the first QoS flow. The first condition may be satisfied if radio access network (RAN) capabilities associated with the first QoS flow are met. The RAN capabilities associated with the first QoS flow may be met if the first QoS flow is below a QoS flow capacity. The first condition may be based on at least one of: the plurality of SDFs multiplexed onto the first QoS flow, information associated with the plurality of SDFs multiplexed onto the first QoS flow, or an indication that the first QoS flow has the plurality of SDFs multiplexed onto the first QoS flow.

The first network node may send, to the second network node, a first response. The first response may indicate the first QoS flow was denied admission and can be admitted if the first condition is satisfied. The first network node may receive, from the second network node, a second message. The second message may include a second QoS profile. The second QoS profile may be associated with a second QoS flow. The second QoS profile may satisfy a second condition associated with the first condition. The second condition may be satisfied if the second QoS flow has the subset of the plurality of SDFs multiplexed onto the second QoS flow. The second condition may be satisfied if RAN capabilities associated with the second QoS flow are met. The RAN capabilities associated with the second QoS flow may be met if the second QoS flow is below the QoS flow capacity.

The first network node may determine that the second QoS flow can be admitted based on the second QoS profile satisfying the second condition. The first network node may send, to the second network node, a second response. The second response may indicate that the second QoS flow can be admitted.

Examples are provided herein that enable the RAN to consider SDF level information when making admission control decisions. This may enable the RAN to go beyond a coarse grained QoS flow level information. Instances where the RAN node makes admission control decisions may include a PDU session resource management and a handover.

A service data flow (SDF) may refer to data that share common attributes, such as a 5-Tuple(e.g., source IP address, destination IP address, source port range, destination port range, and protocol ID).

In examples, a RAN node (e.g., a first network node) may receive (e.g., from a second network node (e.g., SMF or AMF)) first QoS profile(s) (e.g., enhanced QoS profile(s)). The first QoS profile(s) may include at least information associated with two or more SDFs (e.g., a plurality of SDFs). The plurality of SDFs may be mapped to (e.g., multiplexed onto) one of the QoS flows (e.g., a first QoS flow) associated with the first QoS profile(s). The information associated with the plurality of SDFs (e.g., each SDF) may include information about the QoS that was requested for the SDF (e.g., a QoS reference, request 5GS delay, etc.) and priority information for the SDF (e.g., requested priority and/or SDF importance).

The RAN node may perform admission control. The RAN node may determine to not admit (e.g., denied admission to) the QoS flow (e.g., the first QoS flow) that has two or more SDFs (e.g., the plurality of SDFs) multiplexed onto the QoS flow (e.g., the first QoS flow). The RAN node may (e.g., may then) determine that certain SDFs that are multiplexed into QoS flows cannot be admitted but other SDFs that are multiplexed onto the QoS flow can be admitted. The RAN node may determine the condition(s) (e.g., a first condition) where the QoS flows (e.g., the first QoS) and the SDFs can be admitted (e.g., if the condition(s) are satisfied). For example, the RAN node may determine that a subset of the SDF's multiplexed into a QoS flow (e.g., the first QoS flow) can be accepted only if the other SDFs are rejected or reassigned to a different QoS flow.

The event that triggers the RAN node to perform admission control may be at least one of a packet data unit (PDU) session establishment procedure, a PDU session modification procedure, or a handover procedure.

The RAN node may send a response (e.g., to the second network node (e.g., the SMF or AMF)) indicating the QoS flow (e.g., the first QoS flow) cannot be admitted (e.g., was denied admission). The response may (e.g., may also) include information about which SDF(s) can be accommodated in the QoS flow and/or which SDF(s) cannot be accommodated in the QoS flow. The response may (e.g., may also) indicate the condition(s) (e.g., a first condition) in which the QoS flows (e.g., the first QoS flow) and/or the SDFs can be accepted. For example, the response may specify that the RAN node may accept the QoS flow (e.g., the first QoS flow) if only the SDFs specified as accommodatable/acceptable are multiplexed to the specified QoS flow. The first condition may be based on at least one of: the plurality of SDFs multiplexed onto the first QoS flow, information associated with the plurality of SDFs multiplexed onto the first QoS flow, or an indication that the first QoS flow has the plurality of SDFs multiplexed onto the first QoS flow.

The RAN node may receive (e.g., from the second network node (e.g., the SMF or AMF)) second QoS profile(s) (e.g., new QoS profile(s)), which may include SDF requirements and their priority information.

The second (e.g., new) QoS profile(s) may be created to ensure condition(s) specified by the RAN node are met (e.g., the second QoS profile satisfies a second condition associated with the first condition). The second QoS profile may be associated with a second QoS flow. The second QoS profile(s) may accommodate the requirements of the accepted SDFs. In the received second QoS profile(s), the QoS rules of some SDFs may be changed (e.g., by the SMF using alternative QoS rules).

The RAN node may perform admission control a second time. The RAN may determine that the QoS flows (e.g., the second QoS flow) and their multiplexed SDFs can be accepted (e.g., based on the second QoS profile satisfying the second condition).

The RAN node may send a response to the second network node (e.g., the SMF or AMF). This response may indicate that the QoS flow (e.g., the second QoS flow) can be admitted.

Examples related to multiplexed traffic in a QoS flow are provided herein. In examples, multiple data flows may be multiplexed onto the same QoS flow. For example, if considering downlink data, the user plane function (UPF) may be configured by the SMF to associate data from two different data flows with the same QoS flow. For example, if considering uplink data, the WTRU may be configured by the SMF to associate data from two different data flows with the same QoS flow. The SMF may configure the WTRU and/or UPF to multiplex two different data flows into the same QoS flow because the policy and charging control (PCC) rules may indicate that the two data flows require similar QoS treatment (e.g., their packet delay budget (PDB) and packet error rate (PER) requirements are similar).

Examples related to PDU session resource setups are provided herein.

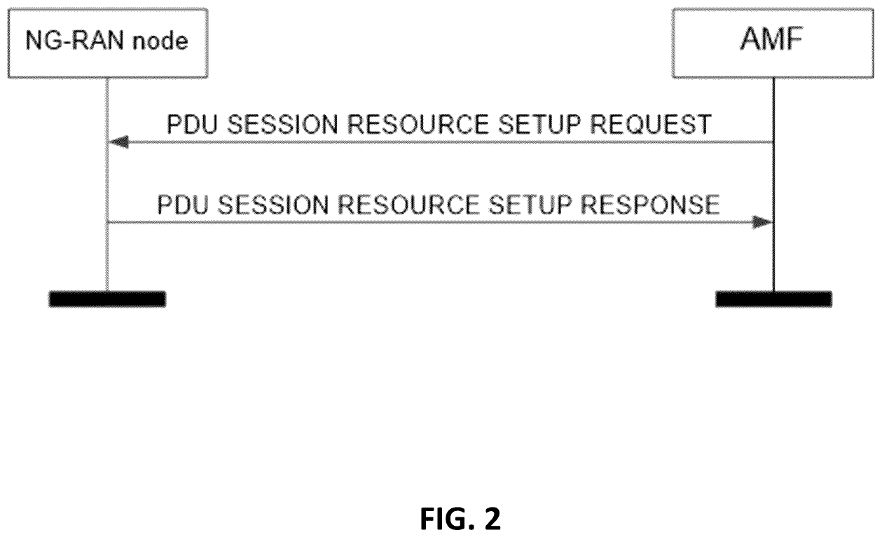

FIG. 2 illustrates example PDU session resource setup procedures. If RAN resources need to be setup for a PDU session, the AMF may send a PDU session resource setup request to the NG-RAN node. This message may include information about at least one PDU session and may indicate the parameters or requirements for the PDU session(s).

If the additional QoS flow information IE is included in the QoS flow level QoS parameters IE within the PDU session resource setup request, the NG-RAN node may consider additional QoS flow information IE for the DRB allocation process. It may be up to NG-RAN node implementation to decide whether and how to use additional QoS flow information IE.

In the event of an unsuccessful operation, the NG-RAN node may report to the AMF the results for each PDU session resource requested to be set up, using the PDU session resource setup response message. This report may include a list of QoS flows that failed to be established, if any, within the QoS flow failed to setup list IE. If the NG-RAN node indicates the unsuccessful establishment of a QoS flow, the cause value may be detailed enough to allow the SMF to understand the reason for the failure (e.g., unsuccessful establishment).

For PDU session resources (e.g., each PDU session resource) that failed to be set up, the PDU session resource setup unsuccessful transfer IE may be included. This IE may include a cause value that may be precise or detailed enough to enable the SMF to understand the reason for the unsuccessful establishment.

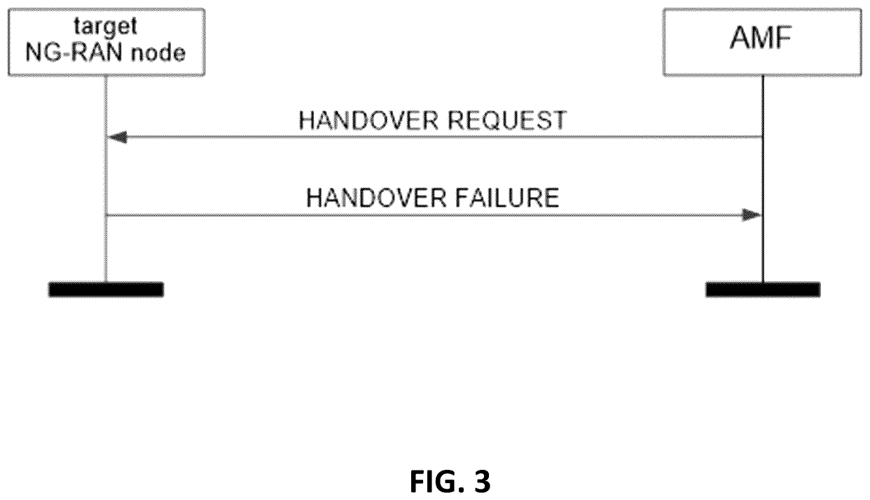

FIG. 3 illustrates example procedures used by the AMF to initiate a handover by sending a handover request message to the target NG-RAN node. If the target NG-RAN node does not admit any of the PDU session resources, or if a failure occurs during the handover preparation, the NG-RAN node may send a handover failure message to the AMF with an appropriate cause value.

Examples of how to enable the RAN node to consider SDF information when making admission control decisions are provided herein.

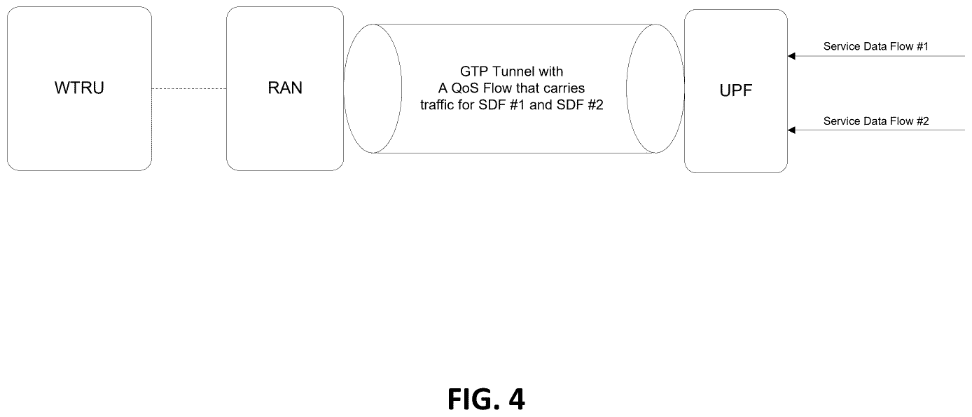

FIG. 4 illustrates an example of multiplexing traffic from multiple SDFs onto a single QoS flow. The UPF can multiplex multiple SDFs onto a single QoS flow and transmit them to the RAN node. The data from the applications may be multiplexed onto the same QoS flow because the traffic from the SDFs shares the same or similar QoS parameters or requirements.

During handover and PDU session management procedures, the RAN node may determine if radio resources are available for one or more (e.g., all) requested QoS flows. If admission control decisions are made, the RAN node may consider QoS flow level information (e.g., requirements of the whole QoS flow), and if QoS flow level requirements cannot be met, the RAN node may reject the request. The process of RAN determining whether or not to admit a QoS flow may be referred to as admission control.

In examples, the RAN may not be aware of whether or not multiple SDFs are multiplexed in a QoS flow. As such, the RAN may not make admission control decisions based on the parameters or requirements of the multiplexed SDFs.

Data flows/SDFs multiplexed within a QoS flow may further be differentiated (e.g., priority of the data flow), and the requirements of the individual SDFs may be taken into consideration, when making admission control decisions (e.g., admit some SDFs and decide how to treat other SDFs separately, instead of rejecting the QoS flow altogether). Making admission control decisions at a granular data flow/SDF level may minimize any reductions to QoS/QoE.

The RAN node may make admission control decisions (e.g., for PDU session establishment and/or handover) based on the QoS profile provided for the QoS flow. Such decisions may be inefficient in cases where multiple SDFs are multiplexed over a single QoS flow. For example, the RAN node may be able to admit a subset of the multiplexed SDFs of the QoS flow. If the RAN node decides not to admit the QoS flow, this may impact all the SDFs multiplexed on this QoS flow (e.g., even the subset of SDFs that could be admitted to the RAN node). The result is that the network may fail to meet the requirements of the subset of SDFs. To address this inefficiency, examples are provided herein to enable the RAN mode to perform admission control decisions considering the parameters or requirements of the multiplexed data SDFs within a QoS flow.

Examples are provided herein to enable the RAN node to consider SDF level information when making admission control decisions. This may enable the RAN node to go beyond coarse grained QoS flow level information. Instances where the RAN node may make admission control decisions may include PDU session resource management and handover.

Examples of SDF-Aware Admission Control in RAN are provided herein.

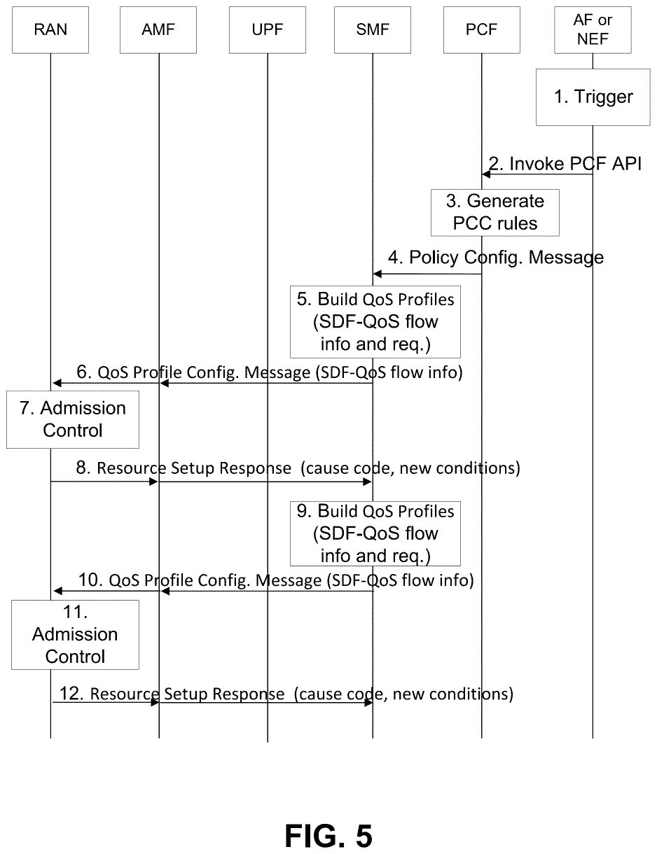

FIG. 5 illustrates an example procedure for how the RAN can make admission control decisions for a QoS flow based on the parameters or requirements of the SDFs that are multiplexed within the QoS flow.

At 1, the application function (AF) or network exposure function (NEF) may be triggered to send SDF and QoS information to the PCF. For example, the NEF may be triggered to send the SDF and QoS information to the policy control function (PCF) by an AF invoking the Nnef_AFsessionWithQoS_Create service operation. For example, the AF may be triggered to invoke a PCF or NEF and provide the SDF information if an AS informs the AF that an application (e.g., new application) is being configured.

At 2, the AF may invoke a PCF application programming interface (API) to provide the network with information about the parameters or requirements of one or more SDFs. This API may be invoked multiple times (e.g., one time to provide requirements for each SDF). For example, the AF may invoke the Npcf_PolicyAuthorization_Create service operation and may provide the network with a flow description (e.g., the description of the SDF) and parameters (e.g., requirements) such as a QoS reference or individual QoS parameters (e.g., a requested 5GS delay, requested priority, requested guaranteed bitrate, requested maximum bitrate, maximum burst size and requested packet error rate). The AF may invoke the Nnef_AFsessionWithQoS_Create service operation. The NEF may (e.g., may then) invoke the Npcf_PolicyAuthorization_Create service operation to provide the SDF and QoS parameters to the PCF.

If the AF invokes the Nnef_AFsessionWithQoS_Create service operation, the AF invokes the Npcf_PolicyAuthorization_Create service operation, or the NEF invokes the Npcf_PolicyAuthorization_Create service operation, the invoker may provide two priority metrics from SDFs (e.g., each SDF). The first priority metric may be the requested priority. The requested priority may be used to determine the allocation and retention priority (ARP) of the QoS flow to which the SDF is assigned. The second priority metric may be an SDF specific priority metric that indicates the priority of the SDF relative to other SDFs that may be assigned to the same QoS flow. The second priority metric may be called an SDF importance metric.

At 3, the PCF may build PCC rules. The PCC rules may include the SDF descriptions and the QoS requirements for SDFs (e.g., each SDF).

The PCC rules may include alternative QoS requirements/rules per SDF, and the PCC rules may be used in combination with the SDF priority indicator to determine if the SDF may be rejected or SDF may still be admitted with the alternative (e.g., but less resource intensive) QoS requirements. For example, the fact that the AF may provide a low priority indicator for an SDF could imply that the guaranteed rate is conditional on enough capacity in RAN. The alternative QoS requirements/rules per SDF and SDF priority indicator may be used to determine which SDF may be multiplexed and/or which SDF may be remapped to a QoS flow that receives a lower QoS (e.g., a QoS flow that may be associated with a lower priority level, higher PDB, or higher PER).

The PCF may include the first and second priority metrics (e.g., requested priority and SDF importance) in the PCC rules.

At 4, the SMF may receive the PCC rules and may use the PCC rules to map the SDFs to QoS flows.

At 5, the SMF may (e.g., may then) build QoS profiles, N4 rules, and QoS rules. The QoS profiles may include information related to SDFs and their requirements to be used for admission control by the RAN node.

For example, the SMF may map two SDFs to a single QoS flow. The SMF may associate the QoS flow with a 5QI value and may associate the QoS flow with a guaranteed bit rate (GBR). The SMF may associate the two SDFs to a QoS flow whose 5QI value and GBR may fulfill the aggregate requirements of both SDFs. For example, the requested guaranteed bitrate of SDF number one may be 3 Mbps, the guaranteed maximum bitrate of SDF number two may be 5 Mbps, and the GBR of the QoS flow may be 8 Mbps.

The QoS profile (e.g., the first QoS profile) may be enhanced to include information about the parameters or requirements of the SDFs that are multiplexed onto a QoS flow. For example, for SDFs (e.g., each SDF of the plurality of SDFs) that are multiplexed in the QoS flow, the QoS profile (e.g., the first QoS profile) may include at least one of: the requested 5GS delay, requested priority, requested guaranteed bitrate, requested maximum bitrate, maximum burst size, or requested packet error rate for the SDF.

At 6, second network node (e.g., the SMF or AMF) may send a first message including the QoS profile(s) (e.g., first QoS profiles), which may include received SDF requirements and their priority information (e.g., information associated with a plurality of PDFs), to the first network node (e.g., the RAN node). The RAN node may store the SDF information in the QoS profile(s) (e.g., the first QoS profile) to be used in events where RAN resources need to be allocated (e.g., during admission control procedures). The plurality of SDFs are multiplexed onto a first QoS flow associated with the first QoS profile. The message that carries the QoS profile (e.g., first QoS profile) to the RAN node, from the second network node (e.g., the SMF or AMF) may be an initial context setup request message, a PDU session resource setup request message, or a handover request message.

At 7, first message may trigger the RAN node to perform admission control. In examples, the RAN node may determine that the QoS flow (e.g., the first QoS flow) that carries a plurality of SDFs (e.g., two SDFs) cannot be admitted (e.g., was denied admission).

The RAN node may use the information associated with the plurality of SDFs to determine that the QoS flow can be admitted if a first condition is satisfied. In examples, the first condition may be satisfied if a subset of the plurality of SDFs (e.g., only one SDF) was carried by the first QoS flow (e.g., multiplexed onto the first QoS flow). The RAN node may determine to send a first response message to the second network node (e.g., SMF) that indicates that the first QoS flow cannot be admitted (e.g., was denied admission). The first response message from the RAN may (e.g., may also) indicate to the SMF which SDF's can be accommodated in the first QoS flow. The first condition may be based on at least one of: the plurality of SDFs multiplexed onto the first QoS flow, information associated with the plurality of SDFs multiplexed onto the first QoS flow, or an indication that the first QoS flow has the plurality of SDFs multiplexed onto the first QoS flow.

In examples, the RAN node may indicate the QoS levels that it may admit. For example, this may be in terms of a 5 QI, a guaranteed flow bit rate (GFBR), a maximum flow bit rate (MFBR), a maximum packet loss rate, whether the RAN node can admit GBR flow or a non-GBR flow, etc. For example, if the RAN node is provided with alternative QoS profiles, the RAN node may indicate which alternative QoS profile it may admit. The alternative QoS profiles may be indexed. The RAN node may provide an indication of the index. For example, the RAN node may provide a percentage reduction in the QoS profile (e.g., first QoS profile). For example, the RAN node may indicate that the RAN node is able to admit K % of the QoS requirement. For example, the RAN node may provide a range of QoS levels that the RAN node is able to admit. For example, the RAN node may admit a QoS flow if the GBR is between K1 and K2 bps.

An example of an event that could trigger the RAN node to perform admission control may be the RAN determining that there is a congestion situation in the RAN node. Another example of an event that could trigger the RAN node to perform admission control may be a handover event. During the handover event, the RAN node may receive the QoS profile from the RAN node that was previously serving the WTRU (e.g., the RAN node that previously admitted the QoS flows).

At 8, the RAN node may send a first response to the second network node (e.g., the SMF or AMF). The first response may indicate that the first QoS flow cannot be admitted (e.g., was denied admission). The first response may (e.g., may also) indicate that the first QoS flow can be admitted if a first condition is satisfied. For example, the first response may include information about which SDF(s) may be accommodated in the QoS flow (e.g., first QoS flow) and which SDF(s) may not be accommodated in the QoS flow (e.g., the first QoS flow). The message (e.g., first response) that carries this information, between the first network node (e.g., the RAN node) and the second network node (e.g., the SMF or AMF), may be an initial context setup response message or a PDU session resource setup response message or a handover request message.

At 9, the second network node (e.g., the SMF or AMF) may configure a second QoS flow(s) (e.g., new QoS flow(s)) associated with a second QoS profile in the RAN node for accommodating the requirements of the accepted SDFs (e.g., based on the information received of the admitted/accepted SDFs and the priority information that is received by the SMF in the PCC rules). The second QoS profile may satisfy a second condition associated with the first condition. The first condition may be satisfied if the first QoS flow has a subset of the plurality of SDFs multiplexed onto the first QoS flow. The second condition may be satisfied if the second QoS flow has the subset of the plurality of SDFs multiplexed onto the second QoS flow. For example, the RAN node may have indicated that SDF #1 could have been admitted but that SDF #2 could not have been admitted. For example, the SMF may configure a first QoS flow that carries SDF #1 with a GBR of 3 Mbps and may configure a second QoS flow that carries SDF #2 but has no GBR. The second QoS flow may not be a GBR QoS flow.

The second network node (e.g., the SMF) may use the first and second priority metrics (e.g., requested priority and SDF importance), which may be received in the PCC rules to make SDF to QoS flow (e.g., new SDF to QoS flow) mapping decisions based on the information that was received from RAN node. For example, an SDF that is associated with a high SDF importance value may be mapped to a QoS flow that is associated with an ARP of higher importance and an SDF that is associated with a lower SDF importance value may be mapped to a QoS flow that is associated with an ARP of lower importance. The SDF that is of lower importance may be assigned to a QoS flow that is of lower priority than what was indicated by the requested priority.

At 10, the second network node (e.g., the SMF or AMF) may send a second message that includes second QoS profile(s) (e.g., new QoS profile(s), which may include SDF requirements and their priority information, to the first network node (e.g., the RAN node). The RAN node may store the SDF information in the second QoS profile(s) for use in events where RAN resources need to be allocated (e.g., during admission control procedures). The second QoS profile may be associated with a second QoS flow. The second QoS profile may satisfy a second condition associated with the first condition. The second condition may be satisfied if the second QoS flow has the subset of the plurality of SDFs multiplexed onto the second QoS flow. The second message that carries the second QoS profile (e.g., new QoS profile) to the first network node (e.g., the RAN node) from the second network node (e.g., the SMF or AMF) may be an initial context setup request message or a PDU session resource setup request message or a handover request message.

At 11, the second message may trigger the RAN node to perform admission control. For example, RAN node may determine that the second QoS flow can be admitted based on the second QoS flow satisfying the second condition (e.g., if the second QoS flow has the subset of the plurality of SDFs multiplexed onto the second QoS flow (e.g., if the second QoS flow carries one SDF)). In examples, both data flows may be admitted after changes to the QoS treatment are made. For example, both data flows may be admitted after secondary/alternative QoS rules are applied to low priority SDFs.

At 12, the first network node (e.g., the RAN node) may send a second response to the network node (e.g., the SMF or AMF). The second response may indicate that the QoS flow (e.g., second QoS flow) can be admitted. The message that carries this information, between the RAN node and the AMF or SMF, may be an initial context setup response message, a PDU session resource setup response message, or a handover request acknowledge message.

In examples, the QoS profile (e.g., the first QoS profile) may be enhanced to provide an indication to the first network node (e.g., the RAN node) that a QoS flow (e.g., the first flow) is used for multiple SDFs (e.g., the first QoS flow has the plurality of SDFs multiplexed onto the first QoS flow). This indication may be used by the RAN node to determine (e.g., in cases where the requested QoS profile requirements cannot be met) whether the RAN node should include some additional information in the first response to the second network node (e.g., SMF) (e.g., RAN capabilities/capacity for the rejected QoS flow). The SMF may (e.g., may then) use the information from the response to determine what actions to take to route the SDFs (e.g., move an SDF to another QoS flow; request a second QoS flow with reduced requirements supported by the RAN as indicated in the response; stop routing an SDF according to priorities; etc.). In examples, the RAN node may determine that the first QoS flow can be admitted if RAN capabilities associated with the first QoS flow are met. The RAN capabilities associated with the first QoS flow may be met if the first QoS flow is below a QoS flow capacity. Based on the first QoS flow being admitted and the RAN capabilities associated with the first QoS flow being met, the RAN node may determine that the second QoS flow can be admitted if RAN capabilities associated with the second QoS flow are met. The RAN capabilities associated with the second QoS flow may be met if the second QoS flow is below the QoS flow capacity.

In these examples, the RAN may not need to be aware of SDF details (e.g., all the SDF details) but may simply be aware that a QoS flow includes multiple SDFs and that the SMF may be explicitly requesting additional information from the RAN to help the SMF decide how to route SDFs in cases where the RAN cannot support the requested QoS profile. The explicit indication from the SMF to the RAN may limit the additional RAN processing to QoS flows (e.g., only those QoS flows) where the SMF may want to re-route and reprioritize SDFs.

These examples may (e.g., may also) keep the SDF-specific logic in the SMF. For example, if there are 10 SDFs in a QoS flow and all SDF information is provided to the RAN, it may be expected that the RAN provides a list of all possible SDF combinations that it can support. In examples, the RAN may provide SDF-independent capability/capacity information to the SMF and let the SMF determine which SDF combinations to use for a QoS flow. The SMF may explicitly request this information from the RAN for select QoS flows.

Examples of reducing signaling between the PCF, NEF, and AF are provided herein. If the AF invokes the Nnef_AFsessionWithQoS_Create service operation, the AF invokes the Npcf_PolicyAuthorization_Create service operation, or the NEF invokes the Npcf_PolicyAuthorization_Create service operation, the invoker may provide alternative QoS parameter sets. The invoker may (e.g., may additionally) provide an indication to the PCF such that the invoker (e.g., the NEF or AF) may not need to be notified if the network determines to change which QoS parameters in the alternative QoS parameter set are applied to the SDF. If the SMF notifies the PCF that the applied QoS parameters have changed, the PCF may not notify the AF or NEF about the changes. The ability for the AF to indicate to the PCF notifications about QoS changes may be useful to reduce signaling between the PCF, NEF, and AF (e.g., in scenarios where the AF may not need to adjust application layer settings in response to changes of QoS settings or in scenarios where the AF is able to detect when the QoE has degraded and that the QoS that is provided by the network has likely changed).

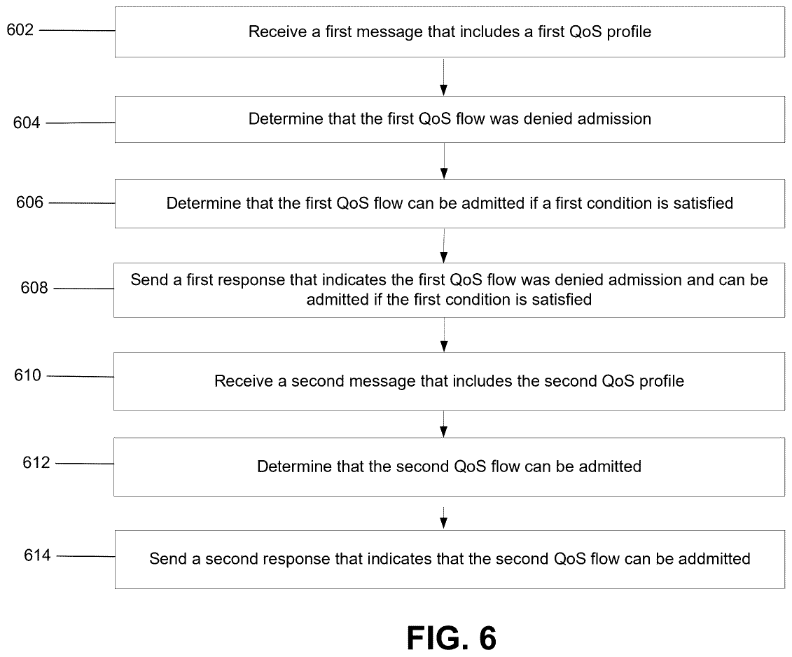

FIG. 6 illustrates an example related to data flow-aware admission control. At 602, a first network node may be configured to receive, from a second network node, a first message. The first network node may be a radio access network (RAN) and the second network node may be a session management function (SMF). The first network node may be a radio access network (RAN) and the second network node may be an access and mobility function (AMF). The first message may include a first quality of service (QoS) profile. The first QoS profile may include information associated with a plurality of service data flows (SDFs). The information associated with the plurality of SDFs may include at least one of: a requested 5GS delay, a requested priority, a requested guaranteed bitrate, a requested maximum bitrate, a maximum burst size, or a request packet error rate for an SDF of the plurality of SDFs. The plurality of SDFs may be multiplexed onto a first QoS flow associated with the first QoS profile.

At 604, the first network node may determine that the first QoS flow was denied admission.

At 606, the first network node may determine that the first QoS flow can be admitted if a first condition is satisfied. The first condition may be satisfied if the first QoS flow has a subset of the plurality of SDFs multiplexed onto the first QoS flow. The first condition may be satisfied if radio access network (RAN) capabilities associated with the first QoS flow are met. The RAN capabilities associated with the first QoS flow may be met if the first QoS flow is below a QoS flow capacity. The first condition may be based on at least one of: the plurality of SDFs multiplexed onto the first QoS flow, information associated with the plurality of SDFs multiplexed onto the first QoS flow, or an indication that the first QoS flow has the plurality of SDFs multiplexed onto the first QoS flow.

At 608, first network node may send, to the second network node, a first response. The first response may indicate the first QoS flow was denied admission and can be admitted if the first condition is satisfied.

At 610, the first network node may receive, from the second network node, a second message. The second message may include a second QoS profile. The second QoS profile may be associated with a second QoS flow. The second QoS profile may satisfy a second condition associated with the first condition. The second condition may be satisfied if the second QoS flow has the subset of the plurality of SDFs multiplexed onto the second QoS flow. The second condition may be satisfied if RAN capabilities associated with the second QoS flow are met. The RAN capabilities associated with the second QoS flow may be met if the second QoS flow is below the QoS flow capacity.

At 612, the first network node may determine that the second QoS flow can be admitted based on the second QoS profile satisfying the second condition.

At 614, the first network node may send, to the second network node, a second response. The second response may indicate that the second QoS flow can be admitted.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A first network node, comprising:
a processor configured to:
receive, from a second network node, a first message that includes a first quality of service (QoS) profile, wherein the first QoS profile comprises information associated with a plurality of service data flows (SDFs), and wherein the plurality of SDFs is multiplexed onto a first QoS flow associated with the first QoS profile;
determine that the first QoS flow was denied admission;
determine that the first QoS flow can be admitted if a first condition is satisfied;
send, to the second network node, a first response that indicates the first QoS flow was denied admission and can be admitted if the first condition is satisfied;
receive, from the second network node, a second message that includes a second QoS profile, wherein:
the second QoS profile is associated with a second QoS flow, and
the second QoS profile satisfies a second condition associated with the first condition;
determine that the second QoS flow can be admitted based on the second QoS profile satisfying the second condition; and
send, to the second network node, a second response that indicates that the second QoS flow can be admitted.

2. The first network node of claim 1, wherein the first condition is based on at least one of:
the plurality of SDFs multiplexed onto the first QoS flow;
information associated with the plurality of SDFs multiplexed onto the first QoS flow; or
an indication that the first QoS flow has the plurality of SDFs multiplexed onto the first QoS flow.

3. The first network node of claim 1, wherein the first condition is satisfied based on the information associated with the plurality of SDFs.

4. The first network node of claim 1, wherein the first condition is satisfied if the first QoS flow has a subset of the plurality of SDFs multiplexed onto the first QoS flow.

5. The first network node of claim 4, wherein the second condition is satisfied if the second QoS flow has the subset of the plurality of SDFs multiplexed onto the second QoS flow.

6. The first network node of claim 1, wherein the first condition is satisfied if radio access network (RAN) capabilities associated with the first QoS flow are met and the second condition is satisfied if RAN capabilities associated with the second QoS flow are met.

7. The first network node of claim 6, wherein the RAN capabilities associated with the first QoS flow are met if the first QoS flow is below a QoS flow capacity and the RAN capabilities associated with the second QoS flow are met if the second QoS flow is below the QoS flow capacity.

8. The first network node of claim 1, wherein the information associated with the plurality of SDFs comprises at least one of: a requested 5GS delay, a requested priority, a requested guaranteed bitrate, a requested maximum bitrate, a maximum burst size, or a request packet error rate for an SDF of the plurality of SDFs.

9. The first network node of claim 1, wherein the first network node is a radio access network (RAN) and the second network node is a session management function (SMF).

10. The first network node of claim 1, wherein the first network node is a radio access network (RAN) and the second network node is an access and mobility function (AMF).

11. A method associated with a first network node, the method comprising:
receiving, from a second network node, a first message that includes a first quality of service (QoS) profile, wherein the first QoS profile comprises information associated with a plurality of service data flows (SDFs), and wherein the plurality of SDFs is multiplexed onto a first QoS flow associated with the first QoS profile;
determining that the first QoS flow was denied admission;
determining that the first QoS flow can be admitted if a first condition is satisfied;
sending, to the second network node, a first response that indicates the first QoS flow was denied admission and can be admitted if the first condition is satisfied;
receiving, from the second network node, a second message that includes a second QoS profile, wherein:
the second QoS profile is associated with a second QoS flow, and
the second QoS profile satisfies a second condition associated with the first condition;
determining that the second QoS flow can be admitted based on the second QoS profile satisfying the second condition; and
sending, to the second network node, a second response that indicates that the second QoS flow can be admitted.

12. The method of claim 11, wherein the first condition is based on at least one of:
the plurality of SDFs multiplexed onto the first QoS flow;
information associated with the plurality of SDFs multiplexed onto the first QoS flow; or
an indication that the first QoS flow has the plurality of SDFs multiplexed onto the first QoS flow.

13. The method of claim 11, wherein the first condition is satisfied based on the information associated with the plurality of SDFs.

14. The method of claim 11, wherein the first condition is satisfied if the first QoS flow has a subset of the plurality of SDFs multiplexed onto the first QoS flow.

15. The method of claim 14, wherein the second condition is satisfied if the second QoS flow has the subset of the plurality of SDFs multiplexed onto the second QoS flow.

16. The method of claim 11, wherein the first condition is satisfied if radio access network (RAN) capabilities associated with the first QoS flow are met and the second condition is satisfied if RAN capabilities associated with the second QoS flow are met.

17. The method of claim 16, wherein the RAN capabilities associated with the first QoS flow are met if the first QoS flow is below a QoS flow capacity and the RAN capabilities associated with the second QoS flow are met if the second QoS flow is below the QoS flow capacity.

18. The method of claim 11, wherein the information associated with the plurality of SDFs comprises at least one of: a requested 5GS delay, a requested priority, a requested guaranteed bitrate, a requested maximum bitrate, a maximum burst size, or a request packet error rate for an SDF of the plurality of SDFs.

19. The method of claim 11, wherein the first network node is a radio access network (RAN) and the second network node is a session management function (SMF).

20. The method of claim 11, wherein the first network node is a radio access network (RAN) and the second network node is an access and mobility function (AMF).
